(19) United States
(12) Patent Application Publication
(10) Pub. No.: US 2017/0055539 A1
(43) Pub. Date: Mar. 2, 2017

(54) METHOD OF PRESERVING FRESHNESS OF HARVESTED CROPS, FRESHNESS PRESERVATION DEVICE, REPOSITORY, AND DISPLAY DEVICE

(71) Applicant: Panasonic Intellectual Property Management Co., Ltd., Osaka (JP)

(72) Inventors: Takashi OHTA, Tokyo (JP); Kazuki HARADA, Osaka (JP); Shinichi AOKI, Osaka (JP); Makoto YAMADA, Osaka (JP)

(73) Assignee: Panasonic Intellectual Property Management Co., Ltd.

(21) Appl. No.: 15/246,283

(22) Filed: Aug. 24, 2016

(30) Foreign Application Priority Data
Sep. 1, 2015 (JP) 2015-172044

(51) Int. Cl. A23B 7/015; H05B 37/02; F21V 23/00; F21V 3/00; A01G 7/04; H05B 33/08

(52) U.S. Cl. CPC A23B 7/015; A01G 7/04; H05B 33/0845; F21V 23/005; F21V 3/00; H05B 37/0281; A23V 2002/00; F21Y 2115/10

(57) ABSTRACT

A method of preserving freshness of a harvested crop includes irradiating the harvested crop with red light.

### CROSS REFERENCE TO RELATED APPLICATION

This application claims the benefit of priority of Japanese Patent Application Number 2015-172044 filed on Sep. 1, 2015, the entire content of which is hereby incorporated by reference.

### BACKGROUND

1. Technical Field

The present disclosure relates to a method of preserving the freshness of a harvested crop, a freshness preservation device, a repository, and a display device.

2. Description of the Related Art

Preserving the freshness of a harvested crop is significantly important as the value of a harvested crop is greatly affected by its freshness. The freshness of a crop can be evaluated based on, for example, weight loss (amount of water lost through transpiration). One conventional technique of preserving the freshness of a crop is refrigeration (for example, see Japanese Unexamined Patent Application Publication No. 2006-76986).

### SUMMARY

However, refrigerating crops can be costly, and there are times when the crops cannot be sufficiently refrigerated, such as during transportation.

The present disclosure provides a method of preserving freshness, a freshness preservation device, a repository, and a display device which are capable of preserving the freshness of a harvested crop with a method different from refrigeration.

According to one aspect of the present disclosure, a method of preserving freshness of a harvested crop includes irradiating the harvested crop with red light.

According to one aspect of the present disclosure, a freshness preservation device for preserving freshness of a harvested crop includes a first illuminant that irradiates the harvested crop with red light.

According to one aspect of the present disclosure, a repository includes the above freshness preservation device and a housing that houses the harvested crop.

According to one aspect of the present disclosure, a display device includes the above freshness preservation device and a shelf for displaying the harvested crop.

Accordingly, the freshness of a crop can be preserved with a method that is different from refrigeration.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is an external perspective view of a repository according to Embodiment 1;

FIG. 2 is a block diagram illustrating the functional configuration of a freshness preservation device including the repository according to Embodiment 1;

FIG. 3 is a flow chart of operations performed by the freshness preservation device according to Embodiment 1;

FIG. 4 illustrates the emission spectrum of red light having a peak wavelength of 630 nm and the emission spectrum of red light having a peak wavelength of 660 nm;

FIG. 5 illustrates the results of Experiment 1;

FIG. 6 illustrates the results of Experiment 2;

FIG. 7 illustrates the results of Experiment 3;

FIG. 8 illustrates the results of Experiment 4;

FIG. 9 is an external perspective view of a display device according to Embodiment 2;

FIG. 10 is a schematic cross section of the display device according to Embodiment 2 when viewed from the side;

FIG. 11 is a block diagram illustrating the functional configuration of a freshness preservation device including the display device according to Embodiment 2;

FIG. 12 illustrates the configuration of a light-emitting module in detail; and

FIG. 13 is a schematic view of a display device according to a different embodiment.

### DETAILED DESCRIPTION OF THE EMBODIMENTS

The following describes a freshness preservation device and the related technologies, according to exemplary embodiments of the present disclosure with reference to the drawings. The exemplary embodiments described below illustrate general or specific examples of the present disclosure. The numerical values, shapes, materials, elements, the arrangement and connection of the elements, steps, and order of the steps, etc., in the following exemplary embodiments are merely examples, and therefore are not intended to limit the inventive concept. Therefore, among the elements in the following exemplary embodiments, those not recited in any of the independent claims defining the most generic part of the inventive concept are described as arbitrary elements.

Note that the drawings are represented schematically and are not necessarily precise illustrations. Moreover, elements that are essentially the same share like reference numerals. As such, duplicate descriptions thereof may be omitted or abridged.

### Embodiment 1

### Repository Configuration

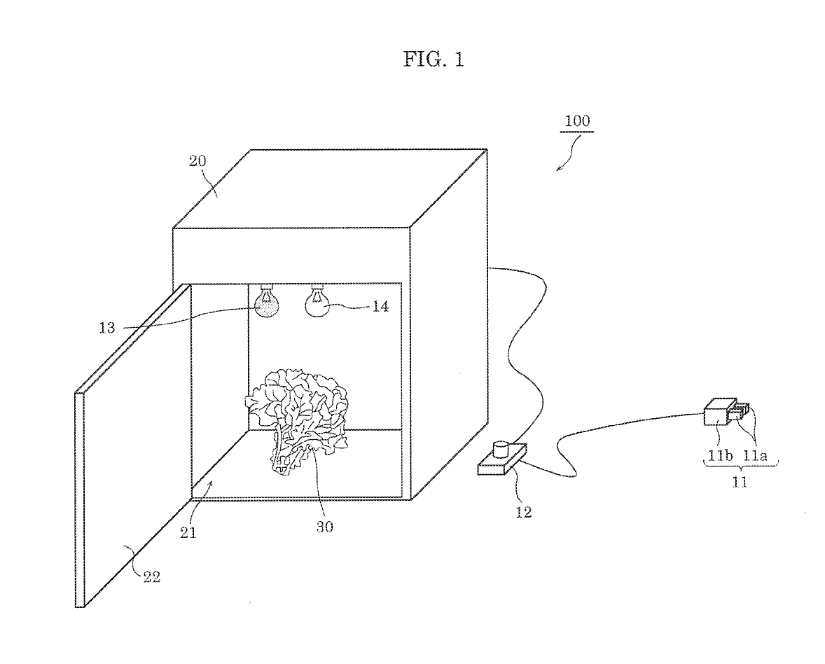

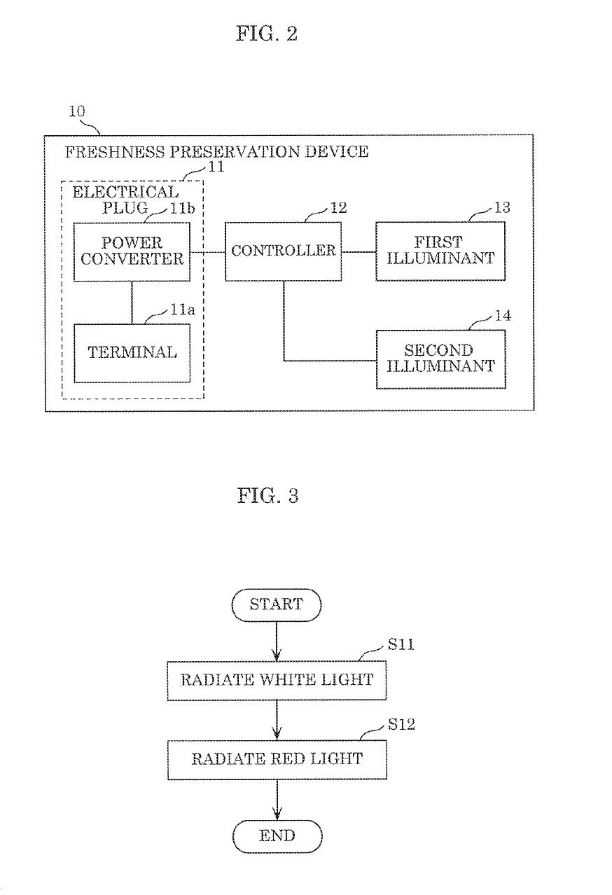

First the configuration of a repository according to Embodiment 1 will be described. FIG. 1 is an external perspective view of the repository according to Embodiment 1. FIG. 2 is a block diagram illustrating the functional configuration of a freshness preservation device including the repository according to Embodiment 1.

Repository 100 illustrated in FIG. 1 houses (stores) harvested crop 30, and is installed in, for example, a storage room of a store that sells crop 30. Repository 100 includes housing 20, door 22, and freshness preservation device 10.

Housing 20 is substantially cuboid in outer form, and crop 80 can be inserted in and removed from storage space 21, which is a cuboid space inside housing 20, via the front of storage space 21. Housing 20 is, for example, made from metal such as aluminum, but may be made from resin. Note that the above shape and material of housing 20 are merely examples; the shape and material of housing 20 are not limited to these examples.

Door 22 (cover) can be opened and closed, and is provided in front of storage space 21. When door 22 is closed and first illuminant 13 and second illuminant 14 are turned off, storage space 21 is dark (an environment of 0 lux).

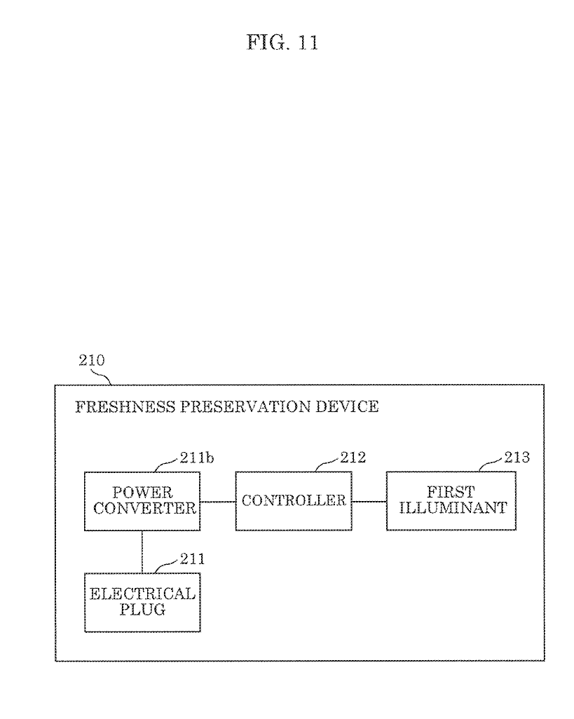

Freshness preservation device 10 is for preserving the freshness of a harvested crop 30. As illustrated in FIG. 11 and FIG. 2, freshness preservation device 10 includes electrical plug 11, controller 12, first illuminant 13, and second illuminant 14.

Electrical plug 11 is one example of an electricity receiver, and includes terminal 11a and power converter 11b. Electrical plug 11 is what is commonly referred to as an AC adapter.

Terminal 11a is a metal terminal that plugs into an electrical outlet. Terminal 11a is not limited to any particular shape or material.

Power converter 11b converts the AC power received by terminal 11a into DC power, and supplies the converted DC power to controller 12, first illuminant 13, and second illuminant 14. Specifically, power converter 11b is an AC-DC converter circuit. Note that in repository 100, power converter 11b is externally provided relative to housing 20, but power converter 11b may be provided internally in housing 20.

First illuminant 13 is a lighting device that is disposed above storage space 21, and, under control by controller 12, radiates red light onto crop 30 stored in storage space 21 in a room temperature environment. Here, red light is, for example, light having an emission peak (emission center wavelength) in a range from 610 nm to 670 nm, inclusive, and an overall emission spectrum in a range from 400 nm to 700 nm, inclusive. Note that first illuminant 13 may radiate red light having an emission peak in a range from 650 nm to 700 nm, inclusive. More specifically, first illuminant 13 is a light-emitting module including a substrate and a plurality of red LEDs mounted on the substrate, but may be implemented in any form that can emit red light. Note that first illuminant 13 is schematically illustrated in FIG. 1, and its shape is not accurately depicted.

Note that the red light (the emission spectrum of the red light) radiated by first illuminant 13 typically has one peak, but may have two or more peaks at mutually different wavelengths. For example, in one experiment, which will be described later, first illuminant 13 radiates red light whose peak wavelength is 630 nm or red light whose peak wavelength is 660 am, but first illuminant 18 may emit red light having both peaks 630 nm and 660 nm. In this case, two types of LEDS—red LEDs whose peak wavelength is 630 nm and red LEDs whose peak wavelength is 660 nm—are mounted on the substrate included in first illuminant 13.

Second illuminant 14 is a radiation device that is disposed above storage space 21, and, under control by controller 12, radiates white light onto crop 30 stored in storage space 21. More specifically, second illuminant 14 irradiates crop 30 with white light while first illuminant 13 irradiates crop 30 with red light. For example, the white light has an overall emission spectrum in a range from 350 nm to 700 nm, inclusive.

Second illuminant 14 is, for example, a chip-on-board (COB) light-emitting module including a substrate, a plurality of blue LEDs directly mounted on the substrate, and a sealant that contains yellow phosphor particles and seals the plurality of blue LEDs. Note that second illuminant 14 may be a surface mount device (SMD) light-emitting module and, alternatively, may be a remote phosphor light-emitting module. Second illuminant 14 may be implemented in any form that can emit white light. Note that second illuminant 14 is schematically illustrated in FIG. 1, and its shape is not accurately depicted.

Note that first illuminant 13 and second illuminant 14 may be configured as a single unit. Such a single unit is, for example, a light-emitting module including a substrate on which two types of light-emitting elements—white LEDs and red LEDs—are mounted. Moreover, such a single unit may be, for example, a light-emitting module that emits white light whose red component is significantly increased as a result of the sealant containing red phosphor particles.

Controller 12 controls first illuminant 13 and second illuminant 14 in accordance with an input made by a user. For example, controller 12 controls the intensity and the radiation time of the red light radiated by first illuminant 13. For example, controller 12 also controls on/off of radiation of light by first illuminant 13, and on/off of radiation of light by second illuminant 14.

Controller 12 may control the intensity of the white light radiated by second illuminant 14.

More specifically, controller 12 is configured of, for example, a PWM control circuit (light dimming circuit) for controlling the illuminance of first illuminant 13, and a timer circuit for controlling the radiation time of first illuminant 13. Controller 12 may be configured as a processor or a microcomputer. Note that in repository 100, controller 12 is externally provided relative to housing 20, but part or all of controller 12 may provided internally in housing 20.

In some embodiments, controller 12 is not utilized. In other embodiments, freshness preservation device 10 preferably includes controller 12. Moreover, the controller for controlling the intensity of the red light and the controller for controlling the radiation time of the red light may be provided as separate controllers. Moreover, controller 12 may be integrally provided with first illuminant 13 and second illuminant 14. Controller 12 is not particularly limited to any specific example, but may include a CPU and a memory storing a program to control the controller.

Note that repository 100 may include a cooling device that cools storage space 21. In other words, repository 100 may be a refrigerator, but repository 100 according to Embodiment 1 does not include a cooling device. Stated differently, repository 100 does not necessarily control the environmental temperature of storage space 21 (the area around crop 30).

Moreover, when repository 100 includes a large storage space 21, crops 30 may be placed on a belt conveyor and the belt conveyor may be ran to sequentially bring crops 30 to a position directly below first illuminant 13 to be irradiated with red light. In other words, crops 30 may be irradiated with red light while being transported in a transportation direction on a belt conveyor.

### (Operations Performed by Freshness Preservation Device)

Next, operations performed by freshness preservation device 10 (the method of preserving freshness) will be described. FIG. 3 is a flow chart of operations performed by freshness preservation device 10.

In a state in which a harvested crop 30 is stored in storage space 21, under control by controller 12, second illuminant 14 radiates white light onto crop 30 stored in storage space 21 (S11). In other words, controller 12 of freshness preservation device 10 causes second illuminant 14 to radiate white light. In some embodiments, the radiation of white light is not utilized.

Next, in a state in which second illuminant 14 is radiating white light, under control by controller 12, first illuminant 13 radiates red light onto crop stored in storage space 21 (812). In other words, controller 12 of freshness preservation device 10 causes first illuminant 13 to radiate red light. The radiation of red light is stopped after, for example, 60 minutes or less of radiation.

### (Experiment 1)

As described above, freshness preservation device 10 irradiates harvested crop 30 with at least red light. With this, freshness preservation device 10 can reduce a reduction in freshness of crop 30. Next, experiments performed using freshness preservation device 10 will be described.

In Experiment 1, spinach was used as crop 30. In Experiment 1, in an environment in which spinach was not irradiated with white light by second illuminant 14 (in an environment of 0 lux), the spinach was left and subjected to the following three conditions, and the change in water retention was measured.

Condition (1): radiating monochromatic red light having a peak wavelength of 630 nm for 60 minutes.

Condition (2): radiating monochromatic red light having a peak wavelength of 660 nm for 60 minutes.

Condition (3): not radiating monochromatic red light.

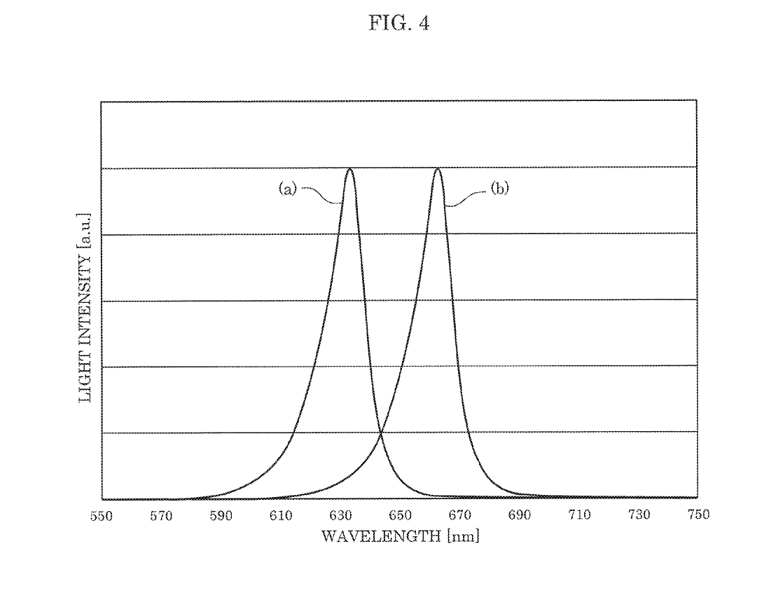

Note that the emission spectrum of the monochromatic red light having a peak wavelength of 630 nm (hereinafter also referred to simply as “630 nm red light”) and the emission spectrum of the monochromatic red light having a peak wavelength of 660 nm (hereinafter also referred to simply as “660 nm red light”) are shown in FIG. 4. FIG. 4 illustrates the emission spectrum of monochromatic red light having a peak wavelength of 630 nm ((a) in FIG. 4) and the emission spectrum of monochromatic red light having a peak wavelength of 660 nm ((b) in FIG. 4). Note that the red light peak wavelengths presented here are merely examples, and the peak wavelength of red light is not particularly limited.

More specifically, Experiment 1 was conducted under the following conditions: temperature of 20 degrees Celsius or less: humidity of 80% or less; and an intensity of radiation of red light of 26 W/ms.

Water retention was calculated with the following formula.

Water retention (%)=(weight after elapse of storage time/weight before irradiation with light)×100

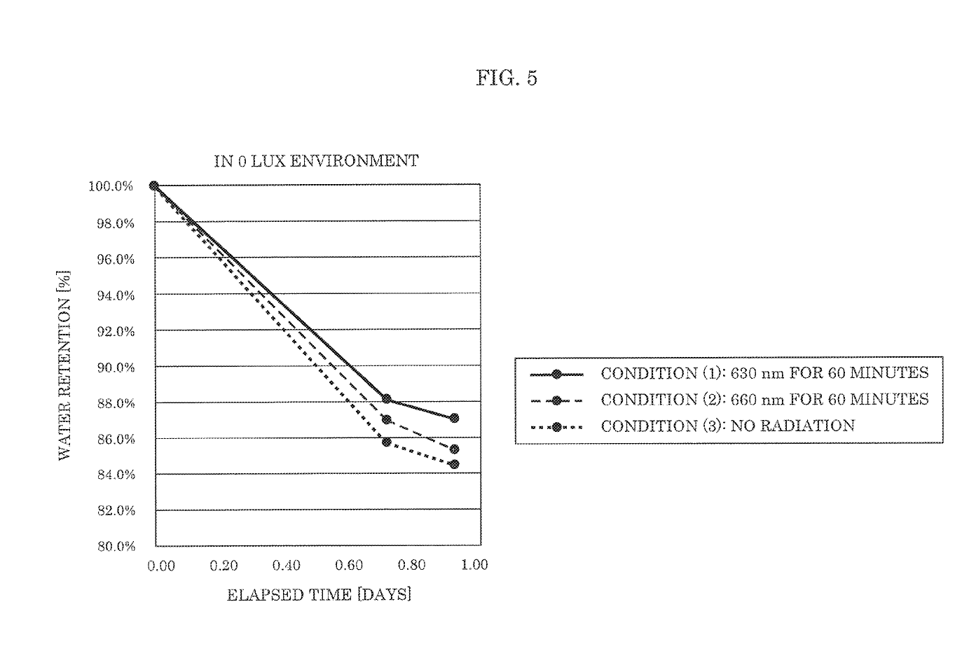

Note that in Experiment 1, under each condition, water retention was calculated for units of spinach n=2 to 3, and the averages of the calculated water retentions are plotted in FIG. 5.

FIG. 5 illustrates the results of Experiment 1. As illustrated in FIG. 5, after subjecting the spinach for 0.7 days and 0.9 days, water retention was highest under Condition 1, second highest under Condition 2, and third highest under Condition 3. In other words, the radiation of red light reduced a reduction in water retention (freshness). Moreover, the results show that the 630 nm red light more greatly reduced a reduction in water retention than the 660 nm red light.

### (Experiment 2)

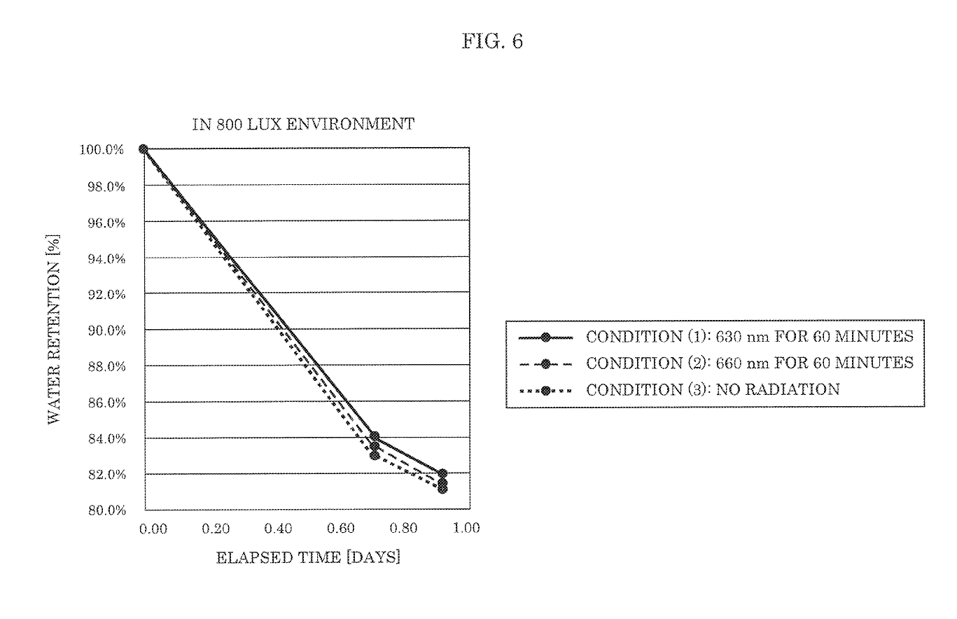

Experiment 2 was performed in an environment of 800 lux achieved by irradiating spinach with white light by second illuminant 14. All other conditions were the same as with Experiment 1. FIG. 6 illustrates the results of Experiment 2.

As illustrated in FIG. 6, after subjecting the spinach for 0.7 days and 0.9 days, water retention was highest under Condition 1, second highest under Condition 2, and third highest under Condition 3. In other words, the radiation of red light reduced a reduction in water retention (freshness). Moreover, the results show that the 630 nm red light more greatly reduced a reduction in water retention than the 660 nm red light.

### (Experiment 3)

In Experiment 3, strawberries were used as crop 30. In Experiment 3, in an environment in which the strawberries were not irradiated with white light by second illuminant 14 (in an environment of 0 lux), the strawberries were left and subjected to the following two conditions, and the change in water retention was measured.

Condition (1): radiating monochromatic red light having a peak wavelength of 660 nm for 60 minutes.

Condition (2): not radiating monochromatic red light.

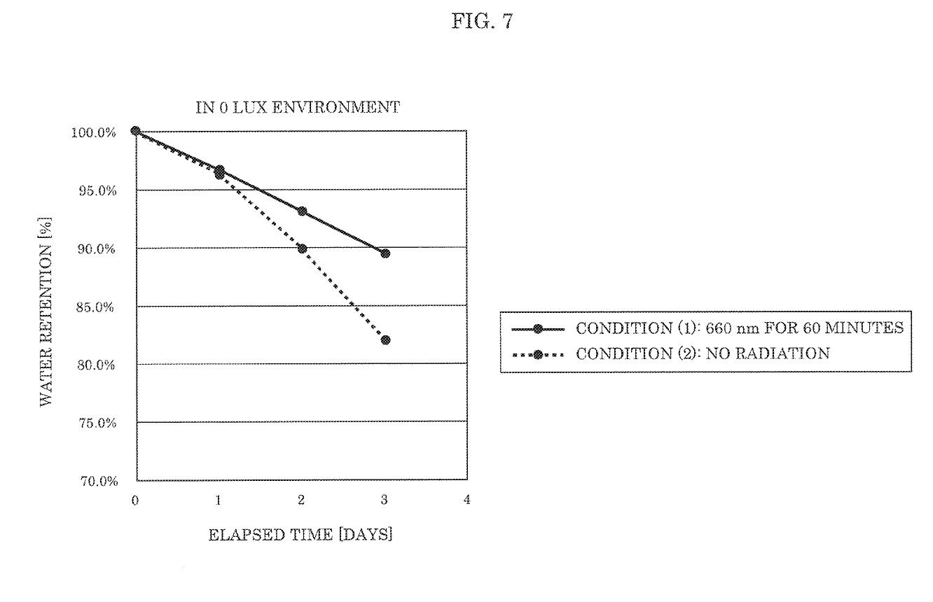

More specifically, Experiment 3 was conducted under the following conditions: temperature of 20 degrees Celsius or less; humidity of 80% or less; and an intensity of radiation of red light of 26 W/m². Note that in Experiment 3, under each condition, water retention was calculated for a number of strawberries n=2 to 3, and the averages of the calculated water retentions are plotted in FIG. 7. FIG. 7 illustrates the results of Experiment 3.

As illustrated in FIG. 7, after subjecting the strawberries for 2 days and 3 days, water retention was highest under Condition 1, and second highest under Condition 2. In other words, the radiation of red light reduced a reduction in water retention (freshness).

### (Experiment 4)

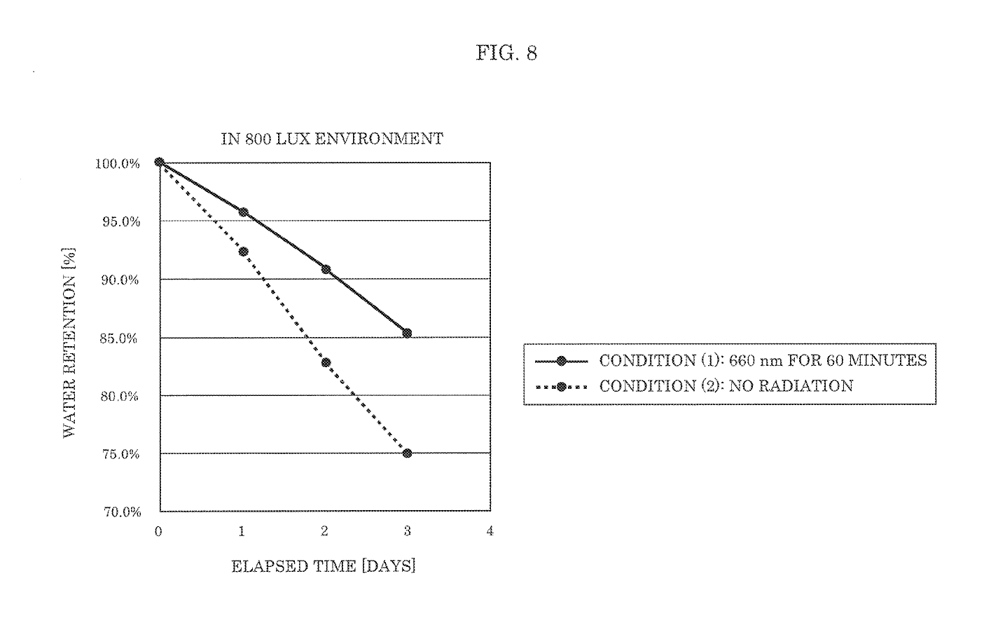

Experiment 4 was performed in an environment of 800 lux achieved by irradiating strawberries with white light by second illuminant 14. All other conditions were the same as with Experiment 3. FIG. 8 illustrates the results of Experiment 4.

As illustrated in FIG. 8, after subjecting the strawberries for 2 days and 3 days, water retention was highest under Condition 1, and second highest under Condition 2. In other words, the radiation of red light reduced a reduction in water retention (freshness).

### (Additional Information on Experiments)

In Experiments 1 through 4 described above, the intensity of radiation of red light was 25 W/m², but a reduction in water retention can be reduced if the intensity of radiation of red light is in a range from 0.5 W/m² to 30 W/m², inclusive. Moreover, even in cases where the intensity of radiation of red light is less than 0.5 W/m² or greater than 30 W/m², compared to when red light is not radiated, a certain degree of freshness preservation can be achieved.

Moreover, in Experiments 1 through 4 described above, the red light was radiated for 60 minutes, but radiating the red light for 60 minutes or less will reduce a reduction in water retention. More preferably, the red light is radiated in a range from 1 minute to 60 minutes, inclusive. Moreover, even in cases where the red light is radiated for longer than 60 minutes, compared to when red light is not radiated, a certain degree of freshness preservation can be achieved.

Moreover, in Experiments 1 through 4 described above, the red light had a peak wavelength of 630 nm or 660 nm, but a peak wavelength in a range between 626 nm and 635 nm, inclusive, will yield similar freshness preservation results to the results of the experiment performed when the red light had a peak wavelength of 630 nm. A peak wavelength in a range between 655 nm and 665 nm, inclusive, will yield similar freshness preservation results to the results of the experiment performed when the red light had a peak wavelength of 660 nm.

### (Advantageous Effects, etc.)

As described above, the method of freshness preservation performed by repository 100 or freshness preservation device 10 is a method of preserving the freshness of a harvested crop 30, and includes irradiating harvested crop 30 with red light.

This sort of method of preserving freshness is capable of reducing a reduction in water retention of crop 30, as shown in the above experimentation results. In other words, the freshness of crop 30 can be preserved with a method that is different from refrigeration.

Moreover, with the method of preserving freshness described above, in a room temperature environment, if one crop 30 is irradiated with monochromatic red light one time, no special treatment is required thereafter. In other words, according to the method of preserving freshness described above, a reduction in water retention of crop 30 can be easily reduced.

Note that the reason why a reduction in water retention of crop 30 can be reduced by irradiating crop 30 with red light is unclear. The inventors presume the radiation of red light narrows the pores of crop 30 which reduces transpiration. As indicated by the results of the above experiments, since radiation of red light is not only effective in terms of freshness preservation for green crops 30 such as spinach, but for red crops 30 such as strawberries as well, the inventors presume that a mechanism different from, for example, photosynthesis is at work.

Furthermore, the emission spectrum of the red light may have one peak and, alternatively, may have two or more peaks at mutually different frequencies.

In this way, with the method of preserving freshness described above, it is possible to reduce a reduction in water retention of crop 30 by irradiating crop 30 with red light having one peak or two or more peaks at mutually different frequencies.

Moreover, the emission spectrum of the red light may have at least one peak in a range from 625 nm to 635 nm, inclusive.

In this way, with the method of preserving freshness described above, it is possible to reduce a reduction in water retention of crop 30 by irradiating crop 30 with red light having a peak in a range from 626 nm to 635 nm, inclusive.

Moreover, the emission spectrum of the red light may have at least one peak in a range from 650 nm to 700 nm, inclusive.

In this way, with the method of preserving freshness described above, it is possible to reduce a reduction in water retention of crop 30 by irradiating crop 30 with red light having a peak in a range from 650 nm to 700 nm, inclusive.

Moreover, the red light may have an emission spectrum in a range from 400 nm to 700 nm, inclusive.

In this way, with the method of preserving freshness described above, it is possible to reduce a reduction in water retention of crop 30 by irradiating crop 30 with red light having an emission spectrum in a range from 400 nm to 700 nm, inclusive.

Moreover, in the method of preserving freshness, harvested crop 30 may be irradiated with white light while harvested crop 30 is being irradiated with red light.

In this way, with the method of preserving freshness described above, it is possible to reduce a reduction in water retention of crop 30 by irradiating crop 30 with red light even in an environment in which crop 80 is illuminated by white light.

Moreover, the red light may have an intensity of radiation in a range from 0.5 W·m⁻² to 30 W·m⁻², inclusive.

In this way, with the method of preserving freshness described above, it is possible to reduce a reduction in water retention of crop 30 by irradiating crop 30 with red light having an intensity of radiation in a range from 0.5 W m⁻² to 30 W·m⁻² inclusive.

Moreover, the red light may be radiated for 60 minutes or less.

In this way, with the method of preserving freshness described above, it is possible to reduce a reduction in water retention of crop 30 by irradiating crop 30 with red light for 60 minutes or less.

Moreover, harvested crop 80 may be one of a vegetable, a fruit, and a flowering plant.

In this way, the method of preserving freshness described above can reduce a reduction in water retention of crop 30 that is a vegetable, fruit, or flowering plant. In other words, the method of preserving freshness described above can reduce a reduction in water retention of a wide variety of crops 30.

Moreover, freshness preservation device 10 is for preserving the freshness of a harvested crop 30, and includes first illuminant 13 that irradiates harvested crop 30 with red light.

With this, freshness preservation device 10 can reduce a reduction in water retention of crop 30. In other words, the freshness of crop 30 can be preserved with a method that is different from refrigeration.

Moreover, freshness preservation device 10 may further include controller 12 that controls at least one of an intensity and a radiation time of the red light radiated by first illuminant 13.

With this, freshness preservation device 10 can control at least one of an intensity and a radiation tune of the red light radiated by first illuminant 13.

Moreover, freshness preservation device 10 may further include second illuminant 14 that irradiates harvested crop 30 with white light while first illuminant 13 irradiates harvested crop 30 with red light.

With this, freshness preservation device 10 can irradiate crop 30 with white light (light for illumination purposes).

Moreover, repository 100 includes freshness preservation device 10 and housing 20 that houses harvested crop 30.

With this, repository 100 can house harvested crop 30 and reduce a reduction in water retention of crop 30.

### Embodiment 2

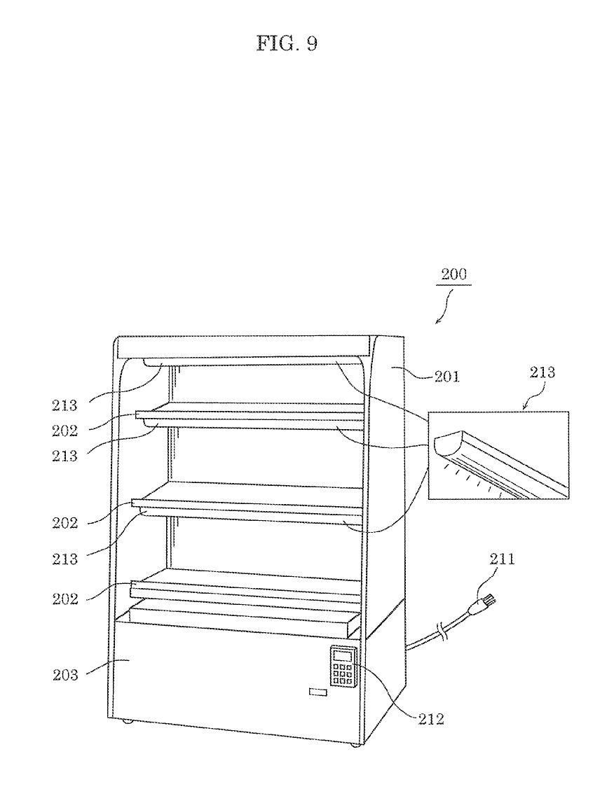

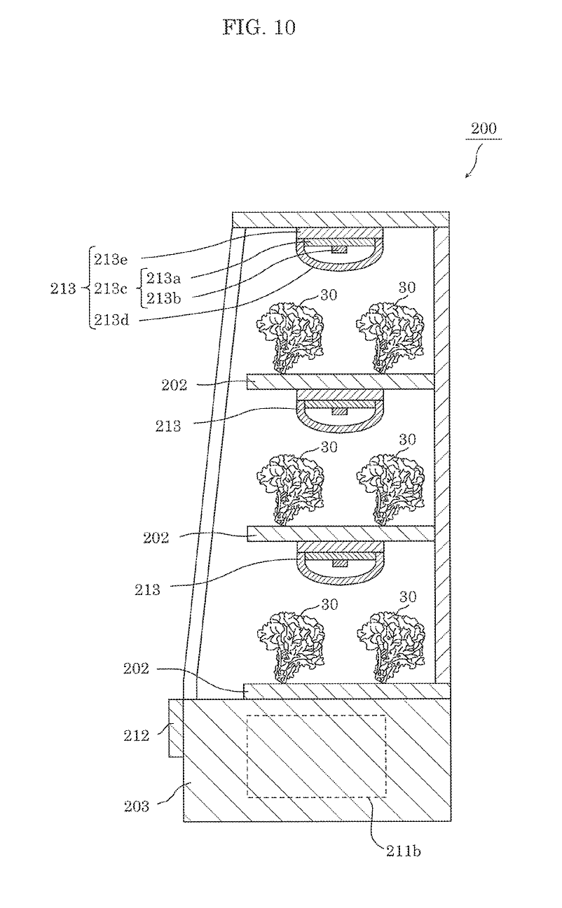

Next, as Embodiment 2, a display device including the freshness preservation device will be described. FIG. 9 is an external perspective view of the display device according to Embodiment 2. FIG. 10 is an external perspective of a schematic cross section of the display device according to Embodiment 2 when viewed from the side. FIG. 11 is a block diagram illustrating the functional configuration of a freshness preservation device including the display device according to Embodiment 2 (hereinafter also referred to as the freshness preservation device according to Embodiment 2.

### (Configuration)

Display device 200 illustrated in FIG. 9 and FIG. 10 includes a plurality of shelves 202 on which harvested crops 30 are displayed (placed), and is installed, for example, on the sales floor of a store that sells crops 30. Display device 200 includes main body 201, shelves 202, base 203, and freshness preservation device 210.

Main body 201 defines the space where crops 30 are stored. Main body 201 includes a side panel, a roof panel, a back panel, and a frame that holds the panels. Main body 201 has an open front. Specifically, main body 201 is made from metal such as aluminum or iron, and resin.

Shelves 202 are plate-shaped components that divide the space defined by main body 201. Harvested crops are displayed on the top surfaces of shelves 202. Main body 201 includes three shelves 202. Specifically, shelves 202 are made from metal such as aluminum or iron, but may be made from resin.

Base 203 acts as the base for display device 200, and controller 212 included in freshness preservation device 210 to be described later is attached to base 203. Moreover, power converter 211b included in freshness preservation device 210 is housed inside base 203.

Next, freshness preservation device 210 will be described with reference to FIG. 11 in addition to FIG. 9 and FIG. 10.

As illustrated in FIG. 9 through FIG. 11, freshness preservation device 210 includes electrical plug 211, power converter 211b, controller 212, and first illuminant 213.

Electrical plug 211 is one example of an electricity receiver, and has a metal terminal that plugs into an electrical outlet. Electrical plug 211 receives AC power from the terminal.

Power converter 211b converts the AC power received by electrical plug 211 into DC power, and supplies the converted DC power to controller 212 and first illuminant 213. Specifically, power converter 211b is an AC-DC convertor circuit. Note that in display device 200, power converter 211b is installed internally in base 203.

Controller 212 controls first illuminant 213 in accordance with an input made by a user. For example, controller 212 controls the intensity and the radiation time of the red light radiated by first illuminant 213. For example, controller 212 also controls on/off of radiation of light by first illuminant 213.

More specifically, controller 212 is configured of, for example, a PWM control circuit (light dimming circuit) for controlling the illuminance of first illuminant 213, and a timer circuit for controlling the radiation time of first illuminant 213. Controller 212 may be configured as a processor or a microcomputer.

First illuminant 213 is disposed above each shelf 202, and, under control by controller 212, radiates red light onto crops 30 displayed on shelf 202. As illustrated in FIG. 10, first illuminant 213 includes: base 213e; light-emitting module 213c including substrate 213a and red LEDs 213b mounted on substrate 213a; and diffusing cover 213d.

Base 213e functions as a base for attaching light-emitting module 213c, as a heat sink for light-emitting module 213c, and also as an attachment component for attaching first illuminant 213 to shelf 202. Base 213e is, for example, made from metal such as die casted aluminum.

Diffusing cover 213d diffuses and transmits red light emitted from light-emitting module 213c, whereby the red light is radiated onto crops 30.

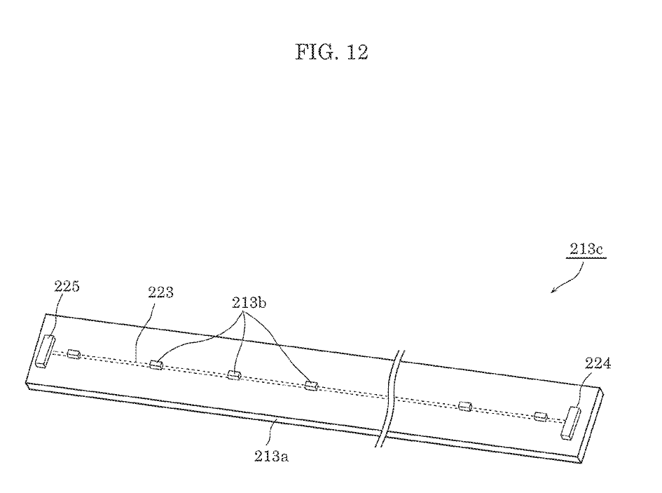

Light-emitting module 213c includes substrate 213a and red LEDs 213b mounted on substrate 213a. Hereinafter, the structure of light-emitting module 213c will be described in detail with reference to FIG. 12. FIG. 12 illustrates the configuration of the light-emitting module in detail.

As illustrated in FIG. 12, light-emitting module 213c includes, in more detail, substrate 2138, a plurality of red LEDs 213b mounted in a single row on substrate 213a, line 223, connector 224, and connector 225.

Substrate 213a is an elongated rectangular substrate. Substrate 213a is a composite epoxy material-3 (CEM-3) substrate whose base material is resin, but substrate 213a may be a different resin substrate, a metal-based substrate, or a ceramic substrate. One example of a different resin substrate is a flame retardant-4 (FR-4) substrate. Examples of ceramic substrates include an alumina substrate and an aluminum nitride substrate. Examples of metal-based substrates include an aluminum alloy substrate, an iron alloy substrate, and a copper alloy substrate.

Red LEDs 213b are one example of the light-emitting elements, and are bare chips that emit monochromatic visible light. Examples of red LEDs 213b include red LEDs made from an AlGaInP material. Red LEDs 213b are, for example, die bonded to substrate 213a with a die attaching material (die boding material).

Line 223 is a metal line made from, for example, tungsten (W) or copper (Cu). Line 223 is formed in a predetermined pattern to electrically connect the plurality of red LEDs 213b together as well as connect the plurality of red LEDs 2138b with connector 224 and connector 225. Note that in FIG. 12, line 223 connects the plurality of red LEDs 213b physically arranged in a single line in series. However, the plurality of red LEDs 213b physically arranged in a single line may be electrically arranged in a plurality of parallel-connected lines of a predetermined number of series-connected red LEDs 213b. In other words, the plurality of red LEDs 213b physically arranged in a single line may be electrically connected in this way by line 223.

Connector 224 and connector 225 are connectors for feeding electricity to light-emitting module 213c. DC power from controller 212 is fed to connector 224 or connector 225. This allows light-emitting module 213c to emit light.

### (Advantageous Effects, etc.)

As described above, display device 200 includes freshness preservation device 210 and shelves 202 on which harvested crops 30 are displayed.

Display device 200 can reduce a reduction in freshness of crops 30 by irradiating harvested crops 30 with red light. Moreover, display device 200 can reduce a reduction in water retention of crops 30 while displaying crops 30.

Note that here, display device 200 is assumed to be installed on the sales floor in a store, as described above. In other words, since display device 200 is used in an environment illuminated by white light, freshness preservation device 210 does not include the second illuminant. However, freshness preservation device 210 may include the second illuminant.

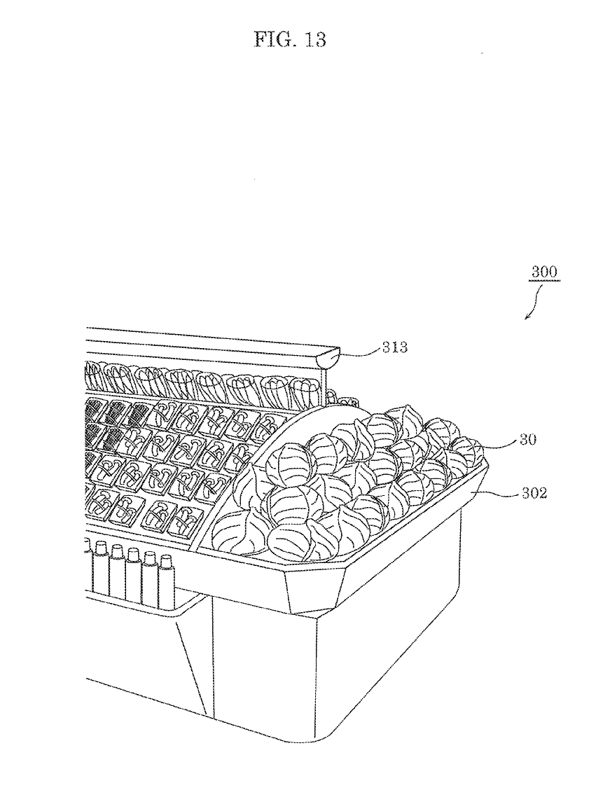

Note that display device 200 is just one example. The present disclosure may be realized as display device 300 illustrated in FIG. 13, for example. FIG. 13 is a schematic view of display device 300 according to a different embodiment.

First illuminant 313 (freshness preservation device) included in display device 300 irradiates crops 30 displayed on shelf 302 with red light. First illuminant 313 has roughly the same configuration as first illuminant 213.

Display device 300 can reduce a reduction in freshness of crops 30 by irradiating harvested crops 30 with red light. Moreover, display device 300 can reduce a reduction in water retention of crops 30 while displaying crops 30.

### (Additional Information for Embodiments)

First, additional information pertaining to the crops will be given. In the above embodiments, “crops” refer to all things that can be harvested with an agricultural method. The “crops” are not particularly limited to a certain type, and include, for example, vegetables, fruits, and flowering plants as commonly classified according to the portion of the plant used (often referred to as horticulture classification or artificial classification).

Vegetables include, for example, vegetable fruit, leafy and stem vegetables, root vegetables, and mushrooms.

Here, vegetable fruits include eggplant, pepinos, tomatoes, mini tomatoes, tamarillos, red peppers, Capsicum annuum, shishito peppers, habanero peppers, green peppers, bell peppers, colored peppers, pumpkins, zucchini, cucumbers, horned melons, Cucumis melo, goya, wax gourd, chayote, sponge gourd, calabash, okra, strawberries, watermelons, muskmelons, Korean melons, and additionally include grains such as corn, and beans such as adzuki beans, string beans, peas, edamame beans, cowpeas, winged beans, fava beans, soybeans, sword beans, peanuts, lentil beans, and sesame seeds.

Leafy and stem vegetables include leafy vegetables such as common iceplant, ashitaba, mustard greens, cabbage, watercress, kale, Japanese 6 mustard spinach, butterhead lettuce, red leaf lettuce, choy sum, sangchu lettuce, santou Chinese cabbage, shiso, Chrysanthemum greens, water-shield, shirona cabbage, Japanese parsley, celery, tatsoi, daikon leaves, Brassica juncea, chisha lettuce, bok choy, Brassica campestris, rapeseed greens, nozawana, napa cabbage, parsley, haruna vegetables, chard, spinach, common henbit, mizuna, Stellaria, Stellaria media, Stellaria aquatica, mibuna greens, Cryptotaenia japonica, Brussels sprouts, mulukhiyah, leaf lettuce, arugula, lettuce, and wasabi leaves; stem vegetables such as leeks, thin leaks, baby scallions, garlic chives, asparagus, Aralia cordata, kohlrabi, zha cai, bamboo shoots, garlic, water spinach, leeks, scallions, and onions; flowering vegetables such as artichokes, broccoli, cauliflower, edible chrysanthemum, nabana, fuki, and myoga; and sprout vegetables such as sprouts, bean sprouts, and kaiware daikon sprouts.

Root vegetables include turnips, daikon, hatsuka daikon, wasabi, horseradish, burdock root, Chinese artichoke, ginger, carrots, Chinese onions, lotus root, tiger lily root, and additionally include potatoes such as sweet potatoes, taro, common potatoes, Chinese yam (yamato yam), and Dioecorea japonica (Japanese mountain yam, wild yam).

Mushrooms include enokitake, Pleurotus eryngii, Auricularia auricula-judae, Phallus indusiatus, shiitake, shimeji, Tremella fuciformis, Pleurotus citrinopileatus, Lactifluus volemus, Pholiota nameko, honey fungus, Lyophyllum decastes, oyster mushroom, white beech mushroom, bunapi-shimeji, porcini, Lyophyllum shimeji, Tricholoma equestre, Grifola frondosa, common mushrooms, matautarke, Hericium erinaceus, Rhizopogon roseolus, and truffles.

Fruits include a variety of citrus fruits such as mandarin oranges; apples, peaches, Asian pears, European pears, bananas, grapes, cherries, silverberries, Rubus berries, blueberries, raspberries, blackberries, mulberries, loquats, figs, persimmons, akebi, mangos, avocados, jujubes, pomegranates, passion fruit, pineapples, bananas, papayas, Armenian plums, Chinese plums, plums, peaches, kiwis, Chinese quince, yamamomo, Castanea crenata, miracle fruit, guava, starfruit, and acerola.

Flowering plants include Hollyhock, bouvardia, Clarkia amoena, evening primrose, stock, flowering cabbage, Lunaria annua, Gladiolus murielae, Iris, gladiolus, California poppy, Peperomia, Calceolaria, Antirrhinum majus, Torenia, Primula sieboldii, Cyclamen persicum, Lampranthus spectabilis, Anthurium, calla lilies, Caladium, Acorus calamus, Syngonium, Spathiphyllum, Dieffenbachia, Philodendron, cactuses, Ajuga, Phyesoetegia virginiana, Salvia, Begonia, Curcuma, Nymphaea, Portulaca, Viola mandehurica, Ammi majus, Setcreasea, Rhoeo spathacea, Tradescantia, Impatiens balsamina, Solanaceae, Petunia, Physealis alkekengi, carnations, Dianthus, Dianthus chinensis, Gypeophila elegans, Gypsophila paniculata, Silene armeria, Guzumania, Strelituia, Phlox subulata, Phlox, Phlox paniculata, Spiraea Japonica, Amacrinum howardlii, Amaryllis, Chrysanthemum, Marguerite, Clivia, Cyrtanthus, Daffodil, Leucojum aestivum, Zephyranthes candida, Nerine, Crinum, Eucharis, Lycoris, Agave, Celosia argentea, Gomphrena globosa, Ipomoea nil, Evolvulus, Tarenaya haseleriana, Pelargonium, Kalanchoe, Scabiosa, Lathyrus odoratus, Lupinus, Lurigio, Myosotis, Astilbe Arendsii group, Saxifraga stolonifera, Agapanthus africanus, Polygonatum odoratum, Aloe, Ornithogalum, Rohdea japonica, Chlorophytum comosum, Hosta, Fritillaria camschatcenais, Gloriosa, Colchicum, Sansevieria trifasciata, Sandersonia aurantiaca, Ophiopogon japonicas, tulips, Tulbaghia, Convallaria majalie, Dracaena, Triteleia, Polygonatum falcatum, Phormium, Fritillaria, Hyacinthus, Tricyrtis hirta, Hemerocallis fulva, Liriope muscari, Lilium, Alstroemeria, Ruscus, Cypripedium macranthos, Calanthe discolor, Oncidium, Cattleya, Colmanara, Bletilla striata, Cymbidium, Coelogyne, Dendrobium, Doitaenopsis, Phalaenopsis japonica, Paphiopedilum, Vanda, Cochlioda, Phalaenopsis Braunau, Miltonia, Exacum, Eustoma russellianum, Gentiana scabra, Lantana camara, Rosa, Cerasus, and Gerbera, and further include plants appreciated for their leaves, such as Cleyera japonica, Cycas revolute, Polypodiopsida, Dracaena, Aspidistra elatior, Monstera, Epipremnum aureum, Dracaena deremensis, Polyecias, Jungle Bush, Stemona japonica, Carex, and Pittosporum tenuifolium.

Although a number of crops have been given as examples above, the method of preserving freshness according to the above embodiments is also applicable to crops other than those given as examples.

Next, additional information pertaining to freshness preservation will be given. In the above embodiments. “freshness preservation” means preserving the freshness of a crop for as long as possible. The freshness preservation required for a crop depends on the type and value of the crop.

For example, for vegetables whose the leaves or stem are mainly used (leafy vegetables), such as lettuce or spinach, preventing withering (reducing a reduction in water retention), preventing color change (for example, etiolating and browning), preventing softening, and preventing molding are important. Moreover, for vegetables whose fruit is mainly used (vegetable fruits), such as strawberries or tomatoes, or for tree fruits such as apples, preventing color change (for example, etiolating and browning), preventing softening, and preventing molding are important. Furthermore, for flowering plants, preventing withering (reducing a reduction in water retention), preventing color change (for example, etiolating and browning), and preventing molding are important.

Next, additional information pertaining to usage of the methods of preserving freshness described in the above embodiments will be given. In the above embodiments, the method of freshness preservation is used in a scenario in which the crop is stored in a storage room of a store or a scenario in which the crop is displayed on the sales floor of a store, but the method of freshness preservation may be used in other scenarios.

The harvested crop is transported to the city in a refrigerated vehicle by, for example, a farmer, an agricultural cooperative, or a specialty establishment that pre-cools the crop. Then, after the harvested crop is purchased by a wholesaler in a market, the crop is stored in a storage room of a supermarket, and then displayed on the sales floor.

In this scenario, the method of preserving freshness can be used in the specialty establishment, refrigerated vehicle, supermarket storage room and sales floor.

Moreover, for example, after the harvested crop passes through the farmer or a first delivery company, the harvested crop is transported in a delivery vehicle to a second delivery company. Then, after the harvested crop is transported for the second time in a delivery vehicle, the harvested crop is transported to a buyer's house (a private home).

In this scenario, the method of preserving freshness can be used in the first delivery company, delivery vehicles, and second delivery company.

Moreover, for example, the method of freshness preservation described in the above embodiments may be used on crops that have not yet been harvested in addition to harvested crops.

Moreover, the red light transmits through typical materials used in containers for the crop (for example, polyethylene). As such, the method of freshness preservation described in the above embodiments can also be used on crops packed in boxes and on crops packed in bags.

Moreover, since red light also permeates through crops, the method of freshness preservation described in the above embodiments can also be used on crops stacked behind other crops.

Moreover, the method of freshness preservation described in the above embodiments may be used in a pitch black (dark) environment, and may be used in an environment illuminated by artificial light, such as light emitted by white LEDs. Moreover, the method of freshness preservation described in the above embodiments may be used under sunlight.

Moreover, after the crop is irradiated with red light, the crop may be stored in a pitch black (dark) environment, may be stored in an environment illuminated by artificial light, such as light emitted by white LEDs, and may be stored under sunlight.

### Other Embodiments

The method of freshness preservation, the freshness preservation device, the repository, and the display device according to the above embodiments have hereinbefore been described, but the present disclosure is not limited to the above embodiments.

For example, in the above embodiments, LEDs are used in the first illuminant and the second illuminant, but the first illuminant and the second illuminant are not limited to the use of LEDs. For example, fluorescent tubes, metal halide lamps, sodium lamps, halogen lamps, xenon lamps, neon tubes, inorganic electroluminescent lamps, organic electroluminescent lamps, chemical luminescent lamps, and lasers may be used in the first illuminant and the second illuminant. Note when a light source that emits light other than red light, such as a fluorescent tube, is used in the first illuminant, a spectral filter that only transmits light of a wavelength corresponding to red light may be used. A plurality of types of light sources may be used in each of the first illuminant and the second illuminant, and the first illuminant and the second illuminant may use mutually different light sources.

Moreover, the form of the radiation of the red light by the first illuminant is not particularly limited. The first illuminant may instantaneously radiate a substantially large amount of light, like a strobe light, for example. Moreover, the first illuminant may radiate a low amount of red light over a long period of time.

Moreover, the first illuminant may continuously radiate red light and, alternatively, may intermittently radiate red light. Here, “continuously radiate” means continuously radiate red light for a predetermined period of time (for example, 5 minutes). Here, “intermittently radiate” means radiating red light for 10 seconds and then not radiating red light for 10 seconds, and repeating this 30 times each to achieve a total radiation time of 5 minutes.

Moreover, in the above embodiments, all or some of the elements (for example, the controller) may be configured as specialized hardware or realized by executing a suitable software program. Each element may be realized by a unit that executes a program, such as a CPU or processor, loading and executing a software program stored in a storage medium such as a hard disk or a semiconductor memory chip.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A method of preserving freshness of a harvested crop, the method comprising irradiating the harvested crop with red light.

2. The method according to claim 1, wherein the red light has an emission spectrum having either one of (i) one peak and (ii) two or more peaks at mutually different wavelengths.

3. The method according to claim 2, wherein the emission spectrum of the red light has at least one peak in a range from 625 nm to 635 nm, inclusive.

4. The method according to claim 2, wherein the emission spectrum of the red light has at least one peak in a range from 650 nm to 700 nm, inclusive.

5. The method according to claim 1, wherein the red light has an emission spectrum in a range from 400 nm to 700 nm, inclusive.

6. The method according to claim 1, further comprising irradiating the harvested crop with white light while irradiating the harvested crop with the red light.

7. The method according to claim 1, wherein the red light has an intensity of radiation in a range from 0.5 W·m⁻² to 30 W·m⁻², inclusive.

8. The method according to claim 1, wherein the red light is radiated for 60 minutes or less.

9. The method according to claim 1, wherein the harvested crop is one of a vegetable, a fruit, and a flowering plant.

10. A freshness preservation device for preserving freshness of a harvested crop, the freshness preservation device comprising a first illuminant that irradiates the harvested crop with red light.

11. The freshness preservation device according to claim 10, further comprising a controller that controls at least one of an intensity and a radiation time of the red light radiated by the first illuminant.

12. The freshness preservation device according to claim 10, further comprising a second illuminant that irradiates the harvested crop with white light while the first illuminant irradiates the harvested crop with the red light.

13. A repository, comprising:
the freshness preservation device according to claim 10; and
a housing that houses the freshness preservation device.

14. A display device, comprising:
the freshness preservation device according to claim 10; and
a shelf for displaying the harvested crop.
